(19) United States
(12) Patent Application Publication
(10) Pub. No.: US 2017/0355616 A1
(43) Pub. Date: Dec. 14, 2017

(54) System for producing crystallized salt and bittern containing amounts of specific minerals

(71) Applicant: JAE HYUN LIM, CRESSKILL, NJ (US)

(72) Inventor: JAE HYUN LIM, CRESSKILL, NJ (US)

(21) Appl. No.: 15/689,279

(22) Filed: Aug. 29, 2017

(51) Int. Cl. C02F 1/04; C01D 3/06; B01D 1/00; E02B 17/02; E02B 17/00; C02F 103/08; C02F 101/10

(52) U.S. Cl. CPC C02F 1/04; E02B 17/02; C01D 3/06; E02B 17/0017; B01D 1/0005; C02F 2101/10; C02F 2103/08

(57) ABSTRACT

The proposed system in which its purpose is to produce crystallized salt and bittern using extracted seawater containing amounts of specific minerals. The seawater is extracted at specific water depths and at a specific offshore location being around underwater volcanic sites where the seawater is affected by volcanic eruption activity. The proposed system further comprises of a refinery facility being a chemical plant for producing specific chemical products using produced crystallized salt and bittern, which contain amounts of specific minerals having amounts of specific chemical elements and specific chemical compounds.

### CROSS-REFERENCE TO RELATED APPLICATIONS

This present Application is a continuation-in-part of U.S. Pat. No. 9,181,102, issued on Nov. 10, 2015, and is claiming the benefits of U.S. Pat. No. 8,894,810, issued on Nov. 25, 2014.

The entire disclosures of all these Patents are incorporated herein by reference.

### FIELD OF INVENTION

A system for producing crystallized salt and bittern containing amounts of specific minerals.

### BACKGROUND OF THE INVENTION

The proposed system can mass produce crystallized salt and bittern which, contain amounts of specific minerals. The proposed system which is situated at a specific offshore location can substitute a system for producing amounts of natural sun-dried salt and bittern through a traditional salt evaporation pond process at a specific onshore location.

The seawater used for the proposed system is extracted at specific water depths and at a specific offshore location, which is around underwater volcanic sites where the seawater is affected by volcanic eruption activity originating from underwater volcanoes, in which underwater volcanoes at spreading ridges and convergent plate boundaries produce hot springs known as hydrothermal vents.

The extracted seawater used for the proposed system contains amounts of specific minerals having amounts of specific chemical elements and specific chemical compounds.

### BRIEF SUMMARY OF THE INVENTION

The proposed system in which its purpose is to produce crystallized salt and bittern through evaporation process using extracted seawater.

The buoyant foundation of the proposed system is reinforced by offshore structures, which are embedded to the seafloor. The buoyant foundation of the proposed system can be a movable structure with a motor propeller installed or a towboat connected to the buoyant foundation.

The components, which are used for the proposed system, such as seawater tanks and evaporator tanks, are fixed on the buoyant foundations situated at specific offshore locations. The seawater tanks are used for extracting seawater at specific water depths and at a specific offshore location, which is around underwater volcanic sites where the seawater is affected by volcanic eruption activity.

The proposed system further comprises of a remotely operated vehicle, which is an underwater robotic device. The remotely operated vehicle is able to measure amounts of specific minerals having amounts of specific chemical elements and specific chemical compounds, using seawater samples which are obtained by a remotely operated vehicle. The remotely operated vehicle can be used for selecting specific positions where the seawater is extracted at specific water depths and at a specific offshore location, which is around underwater volcanic sites where the seawater is affected by volcanic eruption activity.

The seawater extraction vessel is connected to the seawater tank, which is a component for the proposed system, in order to extract seawater at a specific offshore location. The seawater can be extracted by the seawater tank using an installed seawater extraction tube at specific water depths and a specific offshore location, which is around underwater volcanic sites where the seawater is affected by volcanic eruption activity.

The seawater tanks fixed on the buoyant foundations, in which the buoyant foundations are situated at specific offshore locations and in which the seawater tanks are connected to the seawater extraction vessels, are used for extracting seawater. The seawater extraction vessels are situated at specific offshore locations.

The extracted seawater can be delivered by transport vessels to the evaporator tanks, which are components for the proposed system and used for evaporating extracted seawater. The evaporator tanks are separately installed and fixed on the buoyant foundations situated at different offshore locations, such as a harbor facility site protected by installed breakwaters.

The extracted seawater contains amounts of specific minerals having amounts of specific chemical elements and specific chemical compounds.

The proposed system further comprises of a refinery facility. The refinery facility is a chemical plant which is used for producing specific chemical products using produced crystallized salt and bittern. The produced crystallized salt and bittern can be delivered by transport vessels from the components of the proposed system to the refinery facility. The produced crystallized salt and bittern contain amounts of specific minerals originating from extracted seawater, which have amounts of specific chemical elements and specific chemical compounds. The amounts of specific minerals of the specific chemical products can be affected by the produced crystallized salt and bittern. The refinery facility is (a) fixed on the buoyant foundation situated at a specific offshore location or (b) installed at an onshore location.

The warehouse facility, which is used for storing the specific chemical products which are from the refinery facility, can be installed at an onshore location.

### BRIEF DESCRIPTION OF DRAWINGS

FIG. 1 is a top view of an embodiment of components fixed on a buoyant foundation.

FIGS. 2A and 2B are side views of a buoyant foundation with an installed motor propeller and a connected towboat, respectively.

FIG. 3 is a side view of a seawater extraction vessel connected to a seawater tank.

FIG. 4 is a side view of an embodiment of buoyant foundations situated at a specific offshore location, which is around underwater volcanic sites.

FIG. 5 is a top view of a harbor facility site protected by installed breakwaters and a refinery facility installed at an onshore location.

FIG. 6 is a top view of a harbor facility site protected by installed breakwaters and refinery facilities fixed on a buoyant foundation, which is situated at a specific offshore location.

### DETAILED DESCRIPTION OF THE INVENTION

Detailed embodiments of the invention can be illustrated using the accompanying drawings as reference.

A system, in which its purpose is for producing crystallized salt and bittern, using extracted seawater which contains amounts of specific minerals which have amounts of specific chemical elements and specific chemical compounds, is situated at a specific offshore location, which is around underwater volcanic sites where the seawater is affected by volcanic eruption activity.

The seawater used for the proposed system is extracted at specific water depths and at a specific offshore location, which is around underwater volcanic sites where the seawater is affected by volcanic eruption activity originating from underwater volcanoes, in which underwater volcanoes at spreading ridges and convergent plate boundaries produce hot springs known as hydrothermal vents.

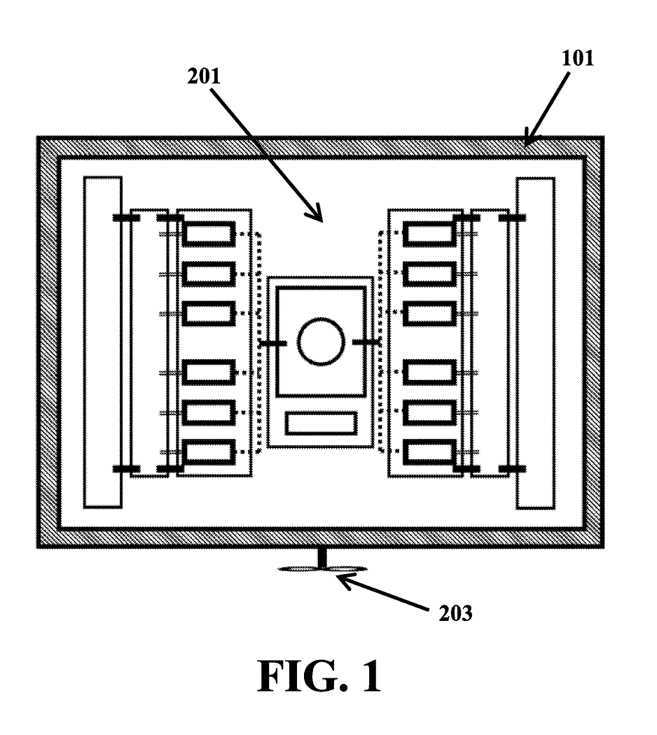

In the embodiment shown in FIG. 1, the components 201 which are used for the proposed system, such as seawater tanks and evaporator tanks, are fixed on the buoyant foundation 101 situated at a specific offshore location.

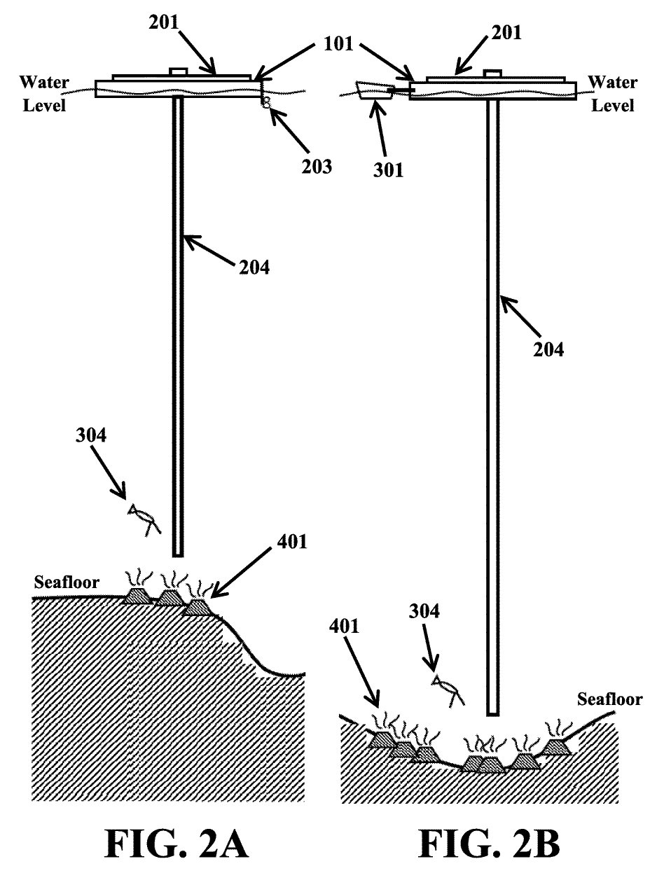

The buoyant foundation 101 of the proposed system can be a movable structure with a motor propeller 203 installed, as shown in FIGS. 1 and 2A, or a towboat 301 connected to the buoyant foundation 101, as shown in FIG. 2B.

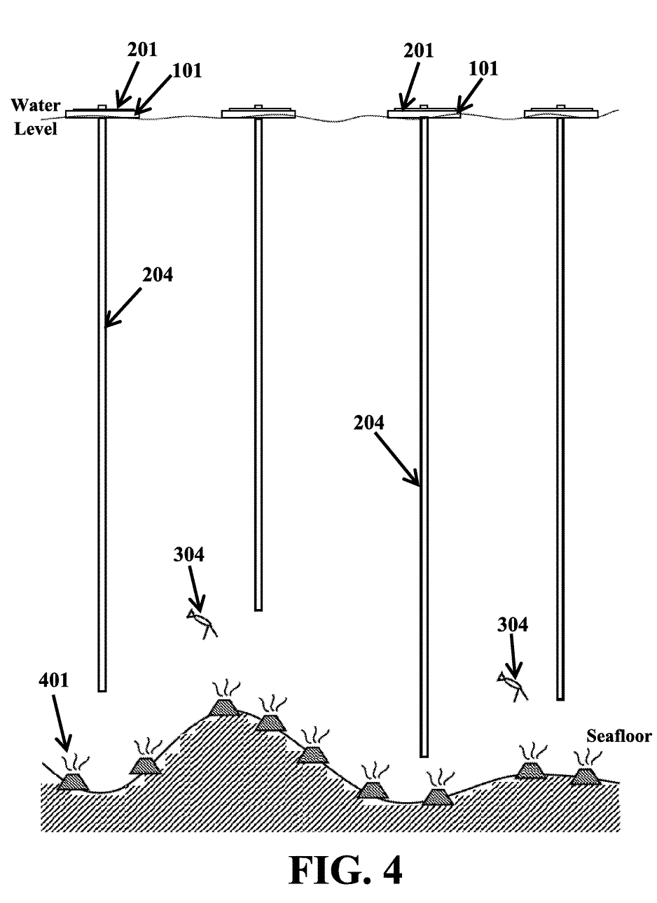

The seawater tanks 202 of the components 201, which are used for extracting seawater. The seawater tanks 202 fixed on the buoyant foundation 101 which are situated at a specific offshore location, which is around underwater volcanic sites where the seawater is affected by volcanic eruption activity originating from underwater volcanoes 401, as shown in FIGS. 2A, 2B, and 4.

The proposed system further comprises of a remotely operated vehicle 304, which is an underwater robotic device. The remotely operated vehicle 304 is able to measure amounts of specific minerals having amounts of specific chemical elements and specific chemical compounds, using seawater samples which are obtained by a remotely operated vehicle 304. The remotely operated vehicle 304 can be used for selecting specific positions where the seawater is extracted at specific water depths and at a specific offshore location which is around underwater volcanic sites where the seawater is affected by volcanic eruption activity, as shown in FIGS. 2A, 2B, 3, and 4.

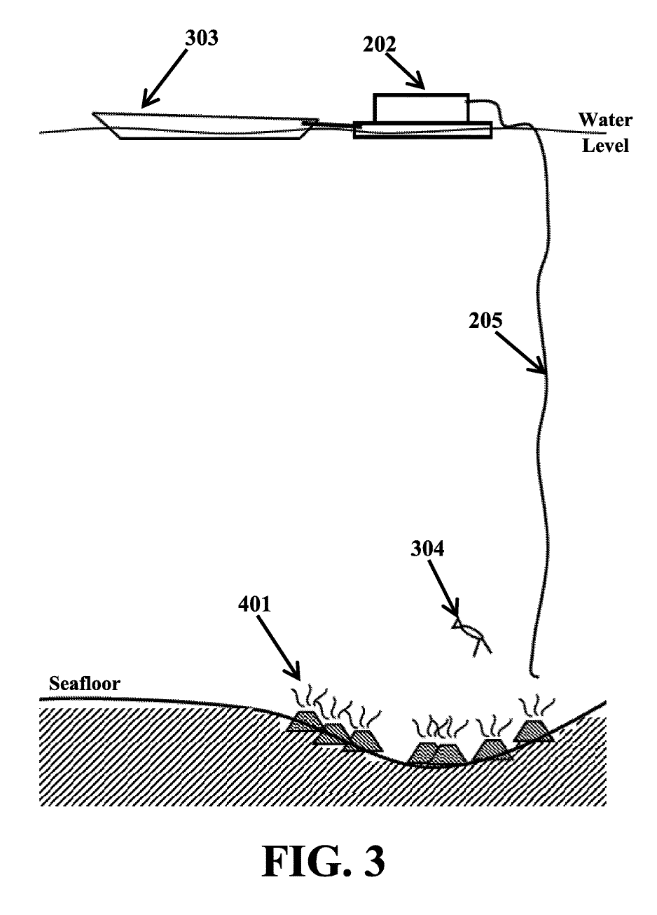

The seawater extraction vessel 303 is connected to the seawater tank 202 which is a component for the proposed system, in order to extract seawater at a specific offshore location, as shown in FIG. 3.

The seawater can be extracted by a seawater tank 202 using an installed seawater extraction tube 205 at specific water depths and a specific offshore location, which is around underwater volcanic sites where the seawater is affected by volcanic eruption activity originating from underwater volcanoes 401, as shown in FIG. 3.

A seawater extraction pipe 204 can be equipped with a seawater tank 202 fixed on the buoyant foundation 101. The seawater extraction pipe 204 is used for extracting seawater at a specific offshore location. The seawater tank 202 of the components 201 can adjust the depths of the seawater extraction pipe 204 in order to extract seawater at specific water depths, as shown in FIGS. 2A, 2B, and 4.

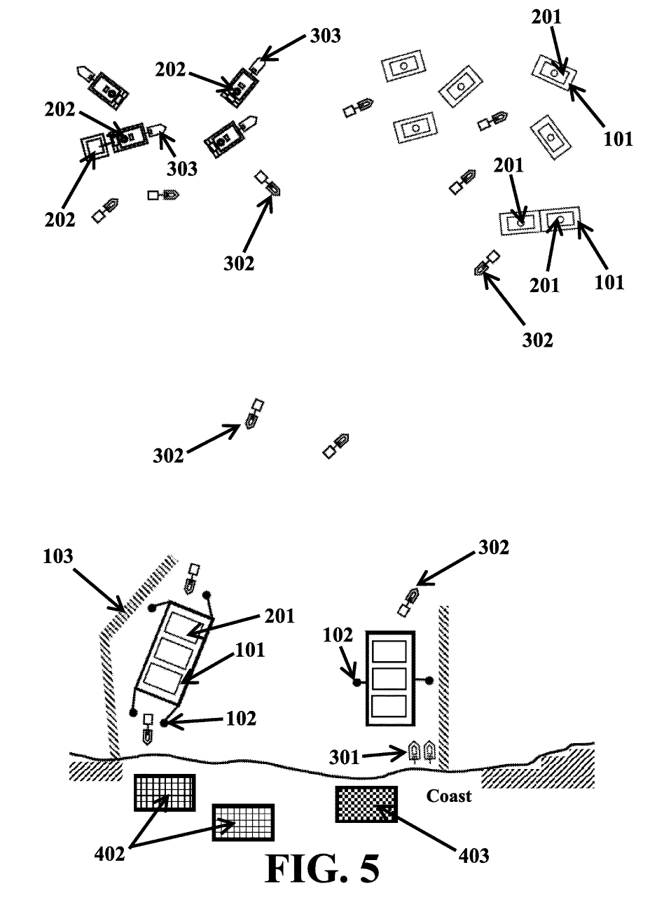

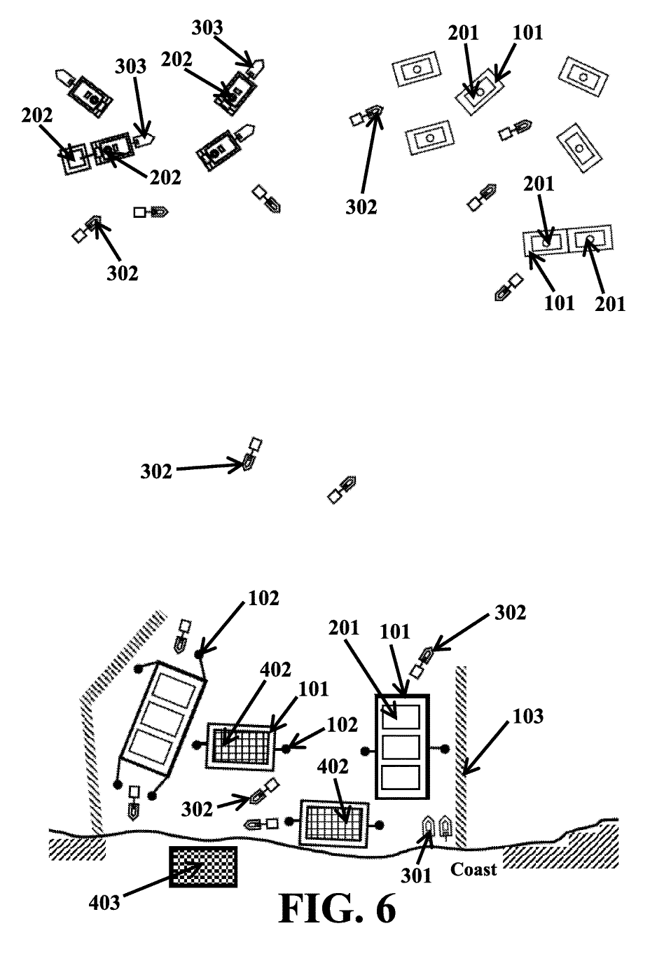

In the embodiments shown in FIGS. 5 and 6, the seawater tanks 202 fixed on the buoyant foundations 101, in which the buoyant foundations 101 are situated at specific offshore locations and in which the seawater tanks 202 are connected to the seawater extraction vessels 303, are used for extracting seawater. The seawater extraction vessels 303 are situated at specific offshore locations. The extracted seawater can be delivered by transport vessels to the evaporator tanks, which are components 201 for the proposed system and used for evaporating extracted seawater. The components 201, such as evaporator tanks, are separately installed and fixed on the buoyant foundations 101 situated at different offshore locations, such as a harbor facility site protected by installed breakwaters 103.

The extracted seawater contains amounts of specific minerals having amounts of specific chemical elements and specific chemical compounds. The specific chemical elements can consist essentially of Aluminium, Antimony, Arsenic, Barium, Bromine, Calcium, Carbon, Chlorine, Cobalt, Copper, Gallium, Gold, Helium, Hydrogen, Indium, Iron, Lead, Lithium, Magnesium, Manganese, Mercury, Molybdenum, Nickel, Oxygen, Potassium, Scandium, Selenium, Silicon, Silver, Sodium, Strontium, Sulfur, Tantalum, Thallium, Tin, Titanium, Tungsten, Vanadium, Yttrium, Zinc, Zirconium, Cerium, Dysprosium, Erbium, Europium, Gadolinium, Holmium, Lanthanum, Neodymium, Praseodymium, Samarium, Terbium, Thorium, Uranium, and Ytterbium.

The specific chemical compounds can consist essentially of Carbon dioxide, Hydrogen sulfide, and Methane.

In the embodiments shown in FIGS. 5 and 6, the proposed system further comprises a refinery facility 402. The refinery facility 402 is a chemical plant which is used for producing specific chemical products using produced crystallized salt and bittern. The produced crystallized salt and bittern can be delivered by transport vessels 302 from the components 201 of the proposed system to the refinery facility 402.

The produced crystallized salt and bittern contain amounts of specific minerals originating from extracted seawater, which have amounts of specific chemical elements and specific chemical compounds. The amounts of specific minerals of the specific chemical products can be affected by the produced crystallized salt and bittern. The refinery facilities 402 are (a) fixed on the buoyant foundation 101 at a specific offshore location or (b) installed at an onshore location.

The refinery facility 402 can be installed on a harbor facility site. The installed breakwaters 103 in a harbor facility site can be used for protecting the components 201 of the proposed system and towboats 301. The buoyant foundation 101 situated at a specific offshore location, such as a harbor facility site, can be reinforced by offshore structures 102, which are embedded to the seafloor.

The warehouse facility 403, which is used for storing the specific chemical products which are from the refinery facility 402, can be installed at an onshore location.

### DRAWING REFERENCE NUMERALS

101 Buoyant Foundation
102 Offshore Structures
103 Breakwaters
201 Components
202 Seawater Tank
203 Motor Propeller
204 Seawater Extraction Pipe
205 Seawater Extraction Tube
301 Towboat
302 Transport Vessel
303 Seawater Extraction Vessel
304 Remotely Operated Vehicle
401 Underwater Volcanoes
402 Refinery Facility
403 Warehouse Facility

What is claimed is:

1. A system situated at a specific offshore location for producing crystallized salt and bittern through evaporation process using extracted seawater by at least one seawater tank, the system comprising:
at least one buoyant foundation being situated on the surface of a body of the seawater, said at least one buoyant foundation comprising:
at least one motor propeller installed or at least one towboat connected to said at least one buoyant foundation, for movement; and
at least one seawater extraction vessel connected to said at least one seawater tank, for extracting the seawater.

2. The system according to claim 1, further comprising at least one remotely operated vehicle is capable of selecting specific positions where the seawater is extracted at specific water depths and at the specific offshore location being around underwater volcanic sites where the seawater is affected by volcanic eruption activity, said at least one remotely operated vehicle being an underwater robotic device for measuring amounts of specific minerals using the seawater samples obtained; and
wherein the extracted seawater contains said amounts of specific minerals having amounts of specific chemical elements and specific chemical compounds.

3. The system according to claim 1, wherein said at least one seawater tank is fixed on said at least one buoyant foundation being situated at the specific offshore location being around underwater volcanic sites where the seawater is affected by volcanic eruption activity, said at least one seawater tank being a component for extracting the seawater; and
wherein the extracted seawater contains amounts of specific minerals having amounts of specific chemical elements and specific chemical compounds.

4. The system according to claim 1, wherein said at least one seawater extraction vessel is connected to said at least one seawater tank being a component for extracting the seawater, said at least one seawater extraction vessel being situated at the specific offshore location being around underwater volcanic sites where the seawater is affected by volcanic eruption activity; and
wherein the extracted seawater contains amounts of specific minerals having amounts of specific chemical elements and specific chemical compounds.

5. The system according to claims 2, 3, and 4, wherein said specific chemical elements consist essentially of Aluminium, Antimony, Arsenic, Barium, Bromine, Calcium, Carbon, Chlorine, Cobalt, Copper, Gallium, Gold, Helium, Hydrogen, Indium, Iron, Lead, Lithium, Magnesium, Manganese, Mercury, Molybdenum, Nickel, Oxygen, Potassium, Scandium, Selenium, Silicon, Silver, Sodium, Strontium, Sulfur, Tantalum, Thallium, Tin, Titanium, Tungsten, Vanadium, Yttrium, Zinc, Zirconium, Cerium, Dysprosium, Erbium, Europium, Gadolinium, Holmium, Lanthanum, Neodymium, Praseodymium, Samarium, Terbium, Thorium, Uranium, and Ytterbium.

6. The system according to claims 2, 3, and 4, wherein said specific chemical compounds consist essentially of Carbon dioxide, Hydrogen sulfide, and Methane.

7. The system according to claim 1, further comprising at least one refinery facility is (a) fixed on said at least one buoyant foundation being situated at the specific offshore location or (b) installed at an onshore location, said at least one refinery facility being a chemical plant for producing specific chemical products using produced said crystallized salt and bittern containing amounts of specific minerals originating from the extracted seawater, such that said amounts of specific minerals of said specific chemical products are affected by said produced crystallized salt and bittern.
